(19) United States
(12) Patent Application Publication
(10) Pub. No.: US 2026/0214016 A1
(43) Pub. Date: Jul. 23, 2026

(54) USING INVERSE REINFORCEMENT LEARNING IN OBJECTIVE-AWARE TRAFFIC FLOW PREDICTION

(71) Applicant: Telefonaktiebolaget LM Ericsson (publ), Stockholm (SE)

(72) Inventors: Hossein SHAFIEIRAD, Toronto (CA); Raviraj ADVE, Toronto (CA); Akram BIN SEDIQ, Kanata (CA); Hamza SOKUN, Ottawa (CA)

(21) Appl. No.: 19/143,110

(22) PCT Filed: Jan. 4, 2024
(86) PCT No.: PCT/IB2024/050088

§ 371 Date: Jun. 25, 2025

Related U.S. Application Data
(60) Provisional application No. 63/478,585, filed on Jan. 5, 2023.

(51) Int. Cl. H04L 41/147; G06N 3/092

(52) U.S. Cl. CPC H04L 41/147; G06N 3/092

(57) ABSTRACT

A method and network node for using inverse reinforcement learning in objective-aware traffic flow prediction are disclosed. According to one aspect, a method in a network node includes generating, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples. The method includes predicting a sequence of samples based at least in part on the values of the reward function.

### FIELD

The present disclosure relates to wireless communications, and in particular, to using inverse reinforcement learning in objective-aware traffic flow prediction.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

The proposed techniques for the problem of network traffic flow prediction can generally be classified into two main categories of statistical-based and machine learning (ML)-based methods. The former is mainly based on analyzing and comparing patterns in the observed data without having any prior knowledge (without training). However, these models are not suitable for scenarios in which the characteristic are too complex and/or different from the scenarios considered in traditional networks (such as cellular or IP backbone networks). Large-scale Intelligent IoT (IIoT) is one example in which the network traffic faces many irregular time-varying fluctuations resulting in the statistics that behave differently from other traffic models considered in the literature.

To alleviate the aforementioned limitation, ML has been used in a wide range of applications as a promising solution for the prediction task in traditional networks (for example, Supervised Learning (SL) has been widely used in this regard). However, the proposed works have their own challenges and limitations when it comes to applying a model used for traditional networks to a different scenario such as the IIoT or 6G.

Some challenges with most of the ML-based network traffic flow prediction approaches are listed as follows:
Machine learning-based network traffic prediction consumes large amounts of computing and memory resources for network management. This is because these algorithms must acquire a large sample of prior network traffic as a training dataset. Collecting such prior network traffic also consumes resources at the network edge:
   Not all network devices and nodes can support sufficient resources for traffic sampling. For instance, the energy of nodes in a wireless sensor network cannot provide sufficient power to deploy network traffic sampling;
The number of end-to-end network traffic increases with the number of nodes in large-scale scenarios. Hence, the computational complexity of predicting the traffic by way of machine learning is greater, which also makes real-time prediction more difficult.

Reinforcement learning (RL) can be considered as an efficient tool to alleviate the challenges with other SL-based approaches. Through interacting with the network, RL can be used to learn the network behavior and predict its future behavior. The main reasons behind why RL can be considered as a potential solution for the recent applications in computer networks include:
Unlike other ML-based approaches, RL does not require a large amount of data pre-sampling and offline training, significantly reducing the required network resources and memory consumption; and
By using RL, instead of only having a trained model for the given data samples (state-action pairs), an agent with a trained policy is created which can be more beneficial for unexpected and previously unseen behaviors.

Traffic prediction in computer networks has been widely studied, including statistical model-based approaches and ML-based solutions.

Statistical-based techniques are mainly based on analyzing patterns in the observed data without any prior knowledge. Linear statistical-based models extract patterns from the historical data and predict future samples according to the lagged data. The general approach is to build a model to extract the features of traffic flows. Autoregressive Moving Average (ARMA) and Autoregressive Integrated Moving Average (ARIMA) are among the best-known methods using statistical techniques for traffic prediction in which the methods of both the AR analysis and moving average (MA) are applied to time-series data that is well-behaved. These approaches work well in stationary conditions and therefore have limitations when applied to large-scale time-varying scenarios in which the statistical characteristics are different from other known models and traditional networks.

ML has been widely used for traffic prediction in computer networks. Among all ML approaches, SL is most often used in prediction models. Since in many networking applications, traffic data is unlabeled, Semi SL and unsupervised learning have also been considered in the literature.

The slow training process of these models is a significant problem in dynamic environments. Moreover, the lack of transparency in the learning process of these models is another limitation.

RL is an efficient approach, used in many objective optimization tasks, which can alleviate the limitations with other ML-based approaches. Regarding the prediction task, an RL framework for traffic flow prediction in IIoT has been proposed where the network traffic prediction problem is modelled as a Markov Decision Process (MDP), and then, predict the network traffic by Monte-Carlo Q-learning. The states are the previously arrived samples and the action is prediction of the current sample. This work considers only the prediction (with no other objectives), and the reward function suggested for the RL agent is the ratio of samples which means the more often a sample occurs in the dataset; a higher value reward is assigned to that action. Essentially, the reward is proportional to the relative frequency that the pair s₁ and s₂ occur in the training dataset in the sense that s₂ follows s₁. The immediate reward when moving from state s₁ to s₂ (where sₜ is the sample arrived at time t) is defined as:

$${r}_{{s}_{1} {s}_{2}} = \frac{{N}_{{s}_{1} {s}_{2}}}{\vert X \vert}$$

where |X| is the number of elements in the training dataset, and Nₛ_{₁}ₛ_{₂} is the number of actions from state s₁ to s₂ in the dataset. The reward for the sequence of w arrived samples is then defined as the average of all immediate rewards of transitions in the sequence, and is used to obtain the prediction policy.

Also, different samples with the same ratio of occurrence in the dataset have the same reward value. In case the prediction is considered to achieve another goal, then if for instance, two samples have the same ratio in the dataset, they might affect the objective differently, and therefore, must be considered differently based on their impact on the performance. Also, for time-varying scenarios in which the ratio of samples changes over time, other features might play a role in designing an efficient reward function used for the RL prediction module.

Deep RL (DRL) may be used for network latency management in Software Defined Networks. They collect the optimal path from the DRL agent and predict future traffic demands using the Long Short-term Memory (LSTM) method (and not RL).

### SUMMARY

Inverse RL (IRL), the field of learning the agent's objectives given its policy or observed behavior (expert behavior), has recently received interest in a wide range of applications such as autonomous driving, robotics, aerial imagery-based navigation, etc. IRL can provide the advantages provided with the RL-based approaches compared to the other ML-based solutions as well as provide a reward function for the RL agent. Therefore, for objective-oriented problems which seek not only the best prediction of the traffic, but also seek to optimize, IRL can achieve an objective-aware reward function to be used for the RL agent. This can involve modification of the reward generated by IRL based on prioritization of the most important samples as well as considering both the prediction accuracy and the objective in order to achieve the reward function (for example, by modifying the loss function used for generating the reward function).

Some embodiments advantageously provide methods and network nodes for using inverse reinforcement learning in objective-aware traffic flow prediction.

Some embodiments includes methods for modeling the network traffic flow prediction task through an IRL framework.

In some embodiments, IRL can be used as an efficient tool for the objective-oriented traffic flow prediction purposes compared to traditional approaches as well as other ML-based techniques.

Some embodiments include modeling the traffic flow prediction problem through an IRL framework and generating a reward function for the traffic flow prediction problem. Some embodiments include modifying the reward function generated by IRL to prioritize the most important samples, and third, using the generated and modified reward to compare the performance of IRL predictor with the state-of-the-art RL-based predictor in an objective-oriented traffic prediction problem. A framework to a scheduling problem in the downlink of a cellular networks with users receiving packets under a max-delay constraint is disclosed herein.

Simulation results demonstrate that, compared to well-known ML-based approaches, IRL may provide better performance while significantly reducing the amount of computation and memory required by using such techniques in real-time objective-oriented prediction scenarios.

IRL results in obtaining the reward function of an agent, given its observed behavior (herein referred to as expert behavior) or policy. The inferred reward function may then be used by an RL agent to get the best policy by observing the expert behavior or the policy used for interpreting the system's behavior. IRL has great potential in case the problem features and objectives are complicated, resulting in a situation where choosing the right reward function is not straightforward. Some advantages of using IRL instead of RL, especially for the problem of network traffic flow prediction, may include one or more of the following:
In case expert behavior is available (or if the given dataset can be re-modelled into expert trajectories as disclosed herein), a close-to-expert policy may be achieved;
In IRL, no reward function is required a priori; this is one of the main challenges in using RL for the task of traffic flow prediction;
In objective-oriented prediction problems, such as the traffic flow prediction problem, the actions that affect the performance more than others may be prioritized. Examples are outcomes that result in a buffer overflow or bursty traffic; and/or
A reward function that (if possible) may be interpreted as a function of desired metrics (e.g., latency, throughput, remaining bandwidth, etc.)

To use IRL for traffic prediction, by observing the transferred data among a large number of nodes, a policy may be generated, based on the observed behavior and the generated reward, capable of imitating the aggregated behavior of all these nodes. Therefore, customers do not need to run a separate traffic generator for each application individually (e.g., consider a multi-cell scenario with base stations distributed within separate cells for the scheduling task. By having the policy for one cell, other cells may use the same policy without the need for generating their own policy in case they all follow the same policy). This may significantly reduce the computational complexity of the predictor.

As another benefit of using IRL, privacy concerns may be addressed through IRL systems. In many scenarios, cloud providers avoid sharing their internal traces with the public due to privacy concerns. One alternative is that customers locally observe the data traces and train an IRL agent based on the locally observed traces. Therefore, in this way, the cloud provider, instead of sharing the data traces with the outside world, may share the trained reward function with the customers, and the customers may use the achieved reward function to train an RL agent.

IRL has been used in autonomous driving or robotics with the goal of the agent learning expert behavior. IRL is not only useful in learning the expert's behavior, but also has been shown to be capable of outperforming the observed behavior, which is another motivation behind exploring IRL as an efficient tool in a wide range of applications including communication systems.

According to one aspect of the present disclosure, a network node is provided. Network node is configured to generate, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples. Network node is configured to predict a sequence of samples based at least in part on the values of the reward function.

According to one or more embodiments of this aspect, generating the reward function includes comparing, by an IRL agent, state action pairs generated by interacting with an environment using state action pairs generated by the expert.

According to one or more embodiments of this aspect, the reward function is generated based at least in part on a priority of samples to be predicted.

According to one or more embodiments of this aspect, the priority of samples to be predicted is based at least in part on whether the samples to be predicted impact an objective.

According to one or more embodiments of this aspect, the priority of samples to be predicted is based at least in part a loss function of a similarity between predicted actions and real actions.

According to one or more embodiments of this aspect, the priority of samples to be predicted is based at least in part on modification of the loss function.

According to one or more embodiments of this aspect, the loss function is determined based at least in part on an objective function.

According to one or more embodiments of this aspect, the network node is configured to schedule, based on an objective, packets of samples arriving in at least one time slot.

According to one or more embodiments of this aspect, generating the reward function is based at least in part on a model of a traffic prediction problem.

According to another aspect of the present disclosure, a method implemented by a network node is provided. Method includes generating, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples. Method includes predicting a sequence of samples based at least in part on the values of the reward function.

According to one or more embodiments of this aspect, generating the reward function includes comparing, by an IRL agent, state action pairs generated by interacting with an environment using state action pairs generated by the expert.

According to one or more embodiments of this aspect, the reward function is generated based at least in part on a priority of samples to be predicted.

According to one or more embodiments of this aspect, the priority of samples to be predicted is based at least in part on whether the samples to be predicted impact an objective.

According to one or more embodiments of this aspect, the priority of samples to be predicted is based at least in part a loss function of a similarity between predicted actions and real actions.

According to one or more embodiments of this aspect, the priority of samples to be predicted is based at least in part on modification of the loss function.

According to one or more embodiments of this aspect, the loss function is determined based at least in part on an objective function.

According to one or more embodiments of this aspect, method includes scheduling, based on an objective, packets of samples arriving in at least one time slot.

According to one or more embodiments of this aspect, generating the reward function is based at least in part on a model of a traffic prediction problem.

According to another aspect of the present disclosure, a computer program is provided. The computer program includes instructions which, when executed on at least one processor, cause the at least one processor to carry out the method according to any one of the foregoing embodiments.

According to another aspect of the present disclosure, a carrier containing the foregoing computer program is provided. The carrier is one of an electronic signal, optical signal, radio signal, or computer-readable medium.

According to another aspect of the present disclosure, a computer-readable medium is provided. The computer-readable medium includes instructions which, when executed on at least one processor, cause the at least one processor to carry out the method according to any one of the foregoing embodiments.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for using inverse reinforcement learning in objective-aware traffic flow prediction;

FIG. 8 is a flowchart of another example process in a network node for using inverse reinforcement learning in objective-aware traffic flow prediction;

FIG. 9 is a graph of performance of using IRL;

FIG. 10 is block diagram of IRL prediction; and

FIG. 11 is a bar chart comparing IRL prediction compared to another method.

### DETAILED DESCRIPTION

Before describing in detail example embodiments, it is noted that the embodiments reside primarily in combinations of apparatus components and processing steps related to using inverse reinforcement learning in objective-aware traffic flow prediction. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Also, although this disclosure describes implementations in terms of a 3GPP wireless communication network, it is understood that the disclosure provided herein may be applicable to other types of wired and wireless networks. Thus, the subject disclosure should be construed as being applicable only to one type of network. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for use of inverse reinforcement learning (IRL) in objective-aware traffic flow prediction.

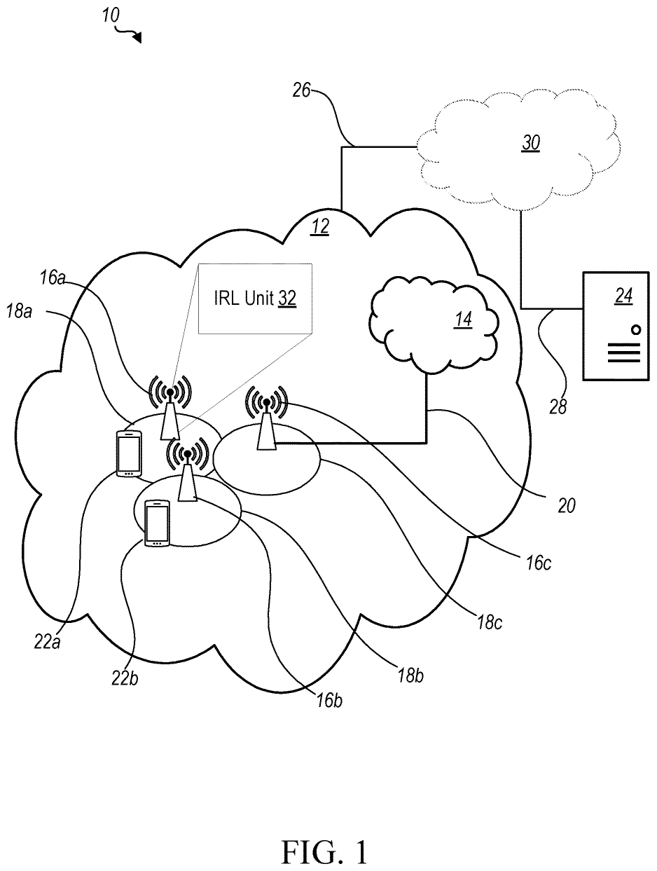

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an IRL unit 32 which is configured to generate by inverse reinforcement learning (IRL) a reward function, based at least in part on observations of behavior of an expert in terms of a sequence of state-action pairs, the expert behavior including predicting a next true sample based on a given set of previously received samples.

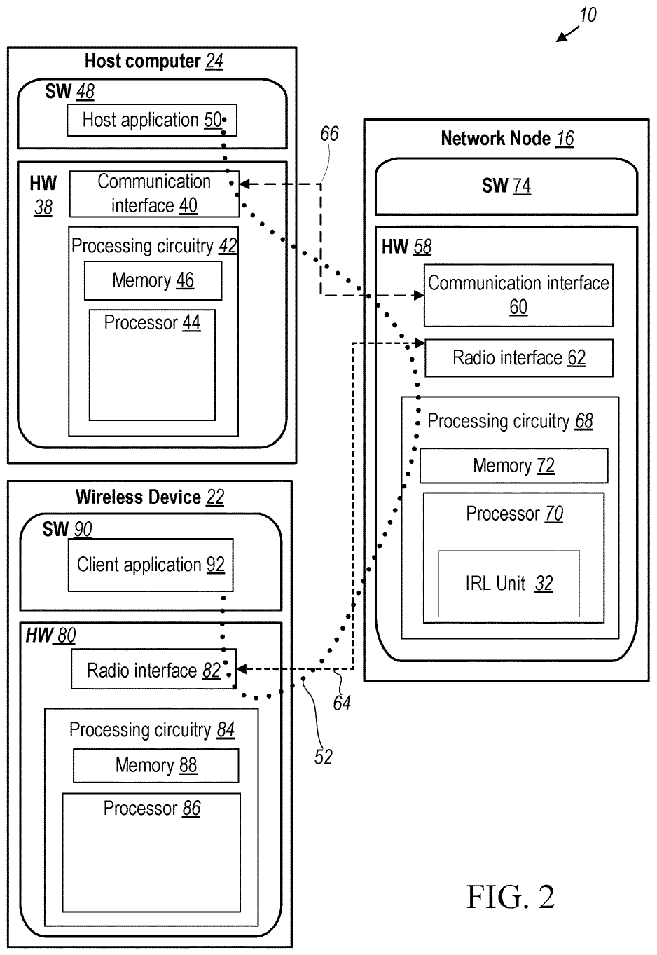

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an IRL unit 32 which is configured to generate by inverse reinforcement learning (IRL) a reward function, based at least in part on observations of behavior of an expert in terms of a sequence of state-action pairs, the expert behavior including predicting a next true sample based on a given set of previously received samples.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as IRL unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

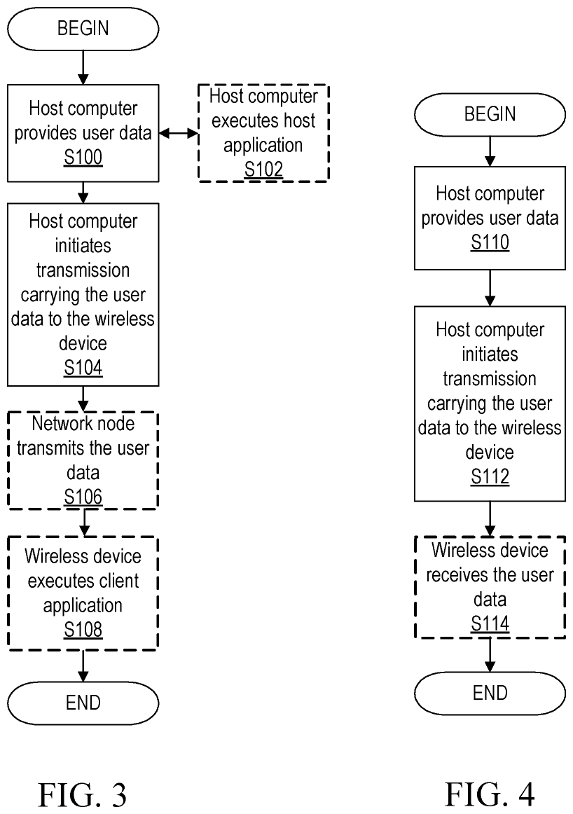

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

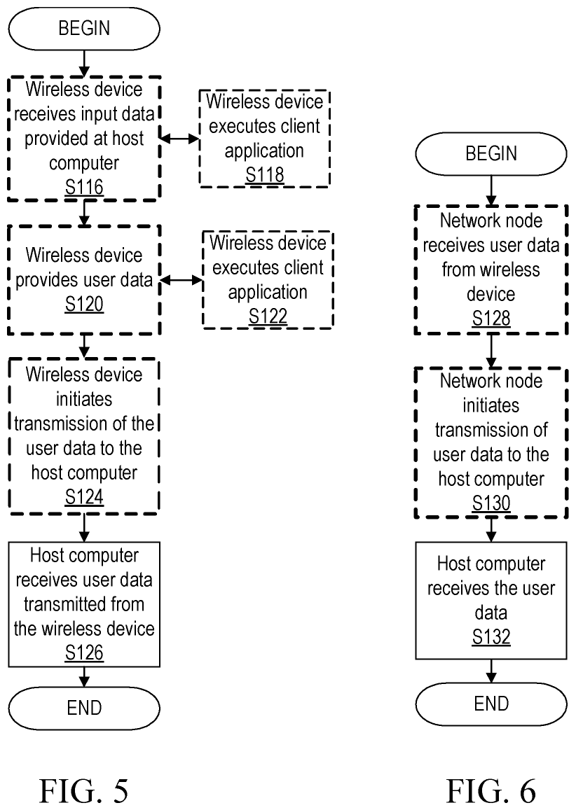

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

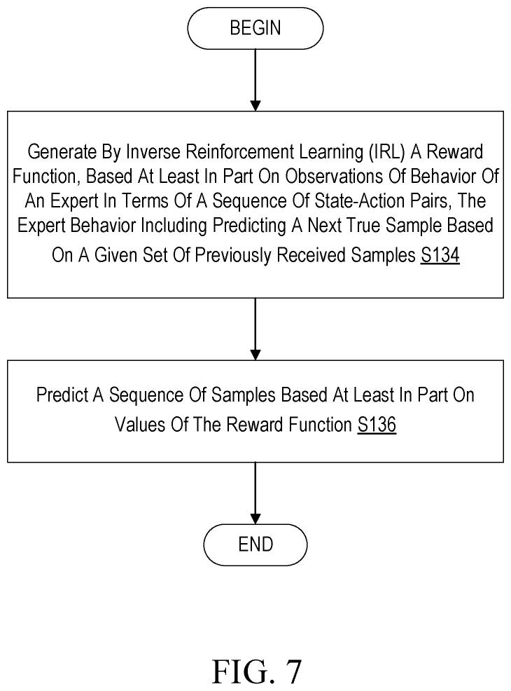

FIG. 7 is a flowchart of an example process in a network node 16 for using inverse reinforcement learning in objective-aware traffic flow prediction. One or more blocks described herein may be performed by one or more elements of network node 16 such as by one or more of processing circuitry 68 (including the IRL unit 32), processor 70, radio interface 62 and/or communication interface 60. Network node 16 such as via processing circuitry 68 and/or processor 70 and/or radio interface 62 and/or communication interface 60 is configured to generate by inverse reinforcement learning (IRL) a reward function, based at least in part on observations of behavior of an expert in terms of a sequence of state-action pairs, the expert behavior including predicting a next true sample based on a given set of previously received samples (Block S134). The process also includes predicting a sequence of samples based at least in part on values of the reward function (Block S136).

In some embodiments, generating the reward function includes comparing by an IRL agent, state action pairs generated by interacting with the environment with state action pairs generated by the expert. In some embodiments, the reward function is generated based at least in part on a priority of samples to be predicted. In some embodiments, a priority of samples to be predicted is based at least in part on whether samples result in a buffer overflow. In some embodiments, a priority of samples to be predicted is based at least in part on modification of a loss function of a similarity between predicted actions and real actions. In some embodiments, the loss function is determined based at least in part on an objective function. In some embodiments, the objective function includes a total number of dropped packets. In some embodiments, the process also includes predicting a size of packets of samples arriving in at least one time slot. In some embodiments, the method includes scheduling the packets of samples based at least in part on a Monte Carlo Tree Search (MCTS). In some embodiments, wherein generating the reward function is based at least in part on a model of a traffic prediction problem as a Markov Decision Process (MDP).

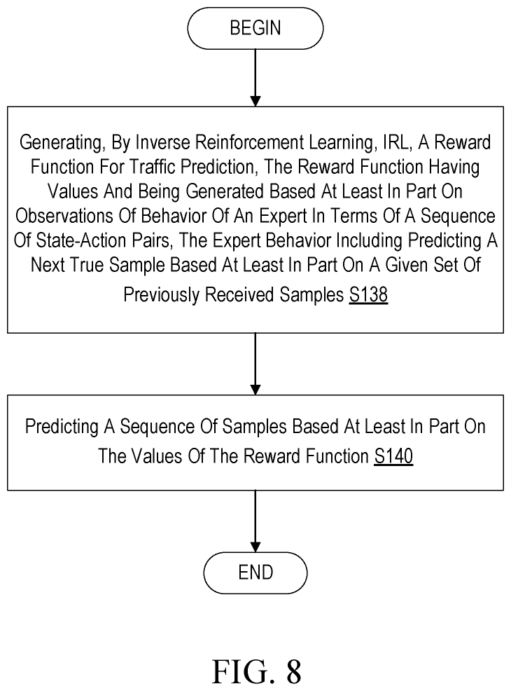

FIG. 8 is a flowchart of another example process in a network node 16 for using inverse reinforcement learning in objective-aware traffic flow prediction. One or more blocks described herein may be performed by one or more elements of network node 16 such as by one or more of processing circuitry 68 (including the IRL unit 32), processor 70, radio interface 62 and/or communication interface 60. Network node 16 is configured to generate, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples (Block S138). Network node 16 is configured to predict a sequence of samples based at least in part on the values of the reward function (Block S140).

In some embodiments, generating the reward function includes comparing, by an IRL agent, state action pairs generated by interacting with an environment using state action pairs generated by the expert.

In some embodiments, the reward function is generated based at least in part on a priority of samples to be predicted.

In some embodiments, the priority of samples to be predicted is based at least in part on whether the samples to be predicted impact an objective.

In some embodiments, the priority of samples to be predicted is based at least in part a loss function of a similarity between predicted actions and real actions.

In some embodiments, the priority of samples to be predicted is based at least in part on modification of the loss function.

In some embodiments, the loss function is determined based at least in part on an objective function.

In some embodiments, network node 16 is configured to schedule, based on an objective, packets of samples arriving in at least one time slot.

In some embodiments, generating the reward function is based at least in part on a model of a traffic prediction problem.

Having described the general process flow of arrangements of the disclosure and having provided examples of hardware and software arrangements for implementing the processes and functions of the disclosure, the sections below provide details and examples of arrangements for using inverse reinforcement learning in objective-aware traffic flow prediction. One or more network node 16 functions described below may be performed by one or more of processing circuitry 68, processor 70, IRL unit 32, etc.

An IRL traffic prediction framework is disclosed. In some embodiments, the IRL's predictor is used in a scheduling problem to show how the objective-oriented traffic prediction works.

How the task of traffic prediction may be modeled as an Markov decision process (MDP) and addressed through IRL framework is disclosed herein. The performance of the disclosed methods is compared with the reinforced learning (RL) framework having the true reward function. For this goal, as an illustrative example, the traffic prediction with a main objective of minimizing the number of dropped packets in a scheduling problem with packets having a maximum delay constraint is considered in the context of the downlink of a cellular network such as that of communication system 10. It is worth noting that the methods disclosed herein may be applied to a wide range of applications with different objectives. For the scheduling problem, consider the system model discussed previously, where full knowledge of the traffic statistics is assumed. However, assume here that no prior information about the statistics of the problem is known, and instead use the IRL predictor.

Regarding the system model for traffic prediction, consider a sequence of K previously-arrived packets, denoted by x=[x₁, x₂, . . . , x_{K}] where xₜ is the size of packet arrived at timeslot t. The packet sizes are assumed to be selected from the set of discrete arrived packet sizes, denoted by A.

For the prediction problem, a goal may be, given the previously arrived samples, to predict the next sample to be as close as possible to the true sample while minimizing the problem's objective (e.g., number of dropped packets in the scheduling problem). Define the state at time t as a window of the last w arrived samples, denoted by Sₜ=[x_{t-w+1}, x_{t-w}2, . . . , xₜ]. The action at timeslot t, denoted by aₜ, is the prediction of the next sample from the set of arrived packet sizes. A goal of some embodiments is to predict the next sample, denoted by aₜ, from the set A, given the state Sₜ defined by the last w arrived samples.

As discussed earlier, for the IRL framework, either the expert's policy or observed behavior may be obtained. In this problem, assume the expert's policy for prediction is not known. IRL generates a reward function by observing the expert's behavior in terms of a sequence of state-action pairs (called trajectories). The IRL agent compares the state-action pairs generated by interacting with the environment with the expert's state-action pairs and in this way generates a reward function which represents the expert's behavior.

The sequence of received data as mentioned above may be interpreted as an expert taking action aₜ (next true sample xₜ₊₁) given state Sₜ (the set of previously arrived w samples). Therefore, the state-action pairs as mentioned above are observed and used as the expert demonstrations required for the IRL agent to generate the reward function. This reward function is then used to train an agent, similar to the RL framework.

Different IRL approaches have been tested to find the best method which may be applied to a problem of interest such as Maximum Entropy IRL, Guided Cost Learning (GCL) and Generative Adversarial Imitation Learning (GAIL). Each of the mentioned techniques may be applied to problems with different specifications. For instance, the max-entropy IRL, a probabilistic approach based on the principle of maximum entropy, requires the knowledge of the state transition probabilities. The GCL is another technique based on deep inverse optimal control via policy optimization. The GCL is an efficient technique which may aid in learning the cost function under unknown dynamics for high-dimensional continuous systems. However, recovering the expert's cost function with IRL, and then extracting a policy from that achieved cost function with RL may be slow (and unstable is some scenarios).

The GAIL technique on the other hand, provides a general framework to directly extract a policy from data as if it were obtained by RL following IRL, and works based on the same concept as imitation learning and generative adversarial networks. We found GAIL more stable and efficient than other techniques tested. In addition, GAIL may be also applied to both discrete and continuous action and state spaces.

In objective-aware scenarios, especially those dealing with multiple objectives, the right choice of reward function is not easy to achieve, and therefore, if possible, IRL may be used compared to RL. In order to demonstrate the benefits of IRL compared to other approaches, consider a scenario in which not only a prediction is sought, but optimization of an objective, as well.

In some embodiments, a main goal in the prediction task is to correctly predict all samples. However, in some scenarios, from the agent's viewpoint, not all samples have the same importance. For instance, consider a network which suffers more from larger flows compared to the smaller ones. Depending on the task, some samples may be prioritized as they might affect the performance more than others. A goal is to avoid mis-prediction of the so-called important samples. This is different from the current the state-of-the-art RL-based scenario using the ratio of actions as the reward function.

In this regard, there are two questions to address: first, how to detect the most important samples; and second, how to benefit from this information about samples. One approach to prioritize one sample or a sequence of samples is to modify the reward function such that the reward value for the most important state-action pairs would be higher than those for which mis-prediction may be tolerated. In order to find the samples to be prioritized, there are at least two approaches. The first approach is to manually find and select the most important samples (in this case, actions). For instance, in some embodiments, the samples (or sequence of samples/actions) resulting into a buffer overflow are found, based on the buffer size and the arrival sample size/rate. This approach is practical only if the number of such actions are not too large compared to the whole action space. The second approach is to find the so-called actions in a data-driven manner by modifying the loss function in the IRL predictor module. The loss function in the reward neural network is a function of the similarity between the predicted and the real actions. However, by combining this loss with the objective as a function of this action, a modified loss function may be obtained that not only a considers the prediction, but also takes the objective into account to generate the reward function. In this way, the actions which affect the objective more than others may be detected automatically while the reward function's neural network gets trained.

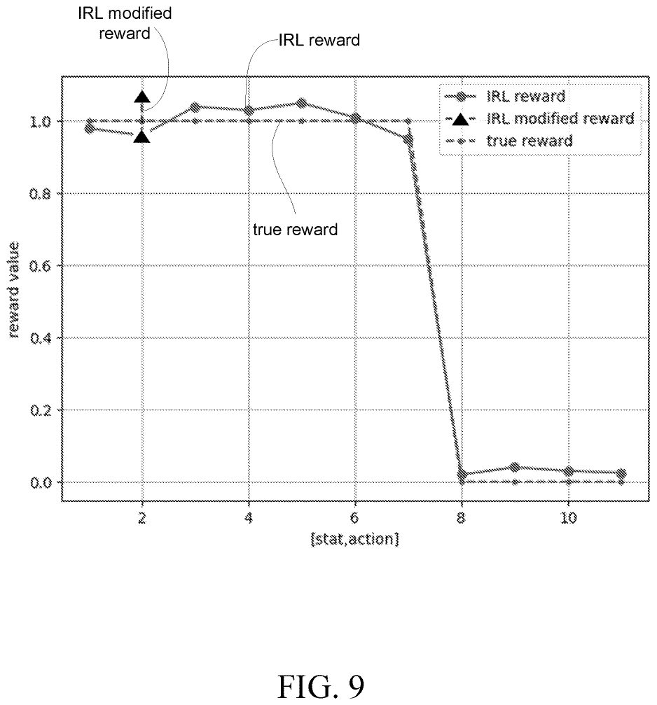

For a small action-state space scenario, FIG. 9 demonstrates the reward generated through IRL as well as the modified reward. FIG. 9 shows a simple scenario with the set of possible arrival packet sizes selected from the set A=[0, 1, 2, 3, 4, 5] with some pre-defined rules. The state is considered as a window of 4 previously arrived samples: Sₜ=[xₜ₋₃, xₜ₋₂, xₜ₋₁, xₜ] where xₜ denotes the packet size of the packet that arrived at time t. The action to create the expert trajectories is the next arrived packet size from the set A, i.e., xₜ₊₁. As shown here, the reward generated by IRL is very close to the true reward, which is equal to 1 (0) if the predicted sample is (not) correct.

FIG. 9 demonstrates the reward function generated by the IRL agent for different state-action pair samples. As mentioned earlier, the IRL agent has been trained only using the discrete actions from the set A. The true reward, calculated based on a pre-defined rule between data samples, is also shown in FIG. 9.

The reward function may be modified for a state-action=([0, 4, 5, 4], 5) assuming this sample affects the objective by causing a buffer overflow for one of the users. As shown in FIG. 9, the new reward value is higher.

Table 1 lists the state-action pairs demonstrated in FIG. 9.

TABLE 1
The reward function generated by IRL
(GAIL) compared to the true reward

| Sample | Action | State |
|---|---|---|
| 1 | 3 | [4, 5, 1, 0] |
| 2 | 0 | [4, 5, 4, 5] |
| 3 | 1 | [3, 2, 4, 5] |
| 4 | 0 | [0, 1, 3, 4] |
| 5 | 2 | [3, 2, 01] |
| 6 | 0 | [3, 3, 4, 5] |
| 7 | 5 | [2, 1, 4, 3] |
| 8 | 4 | [0, 5, 0, 4] |
| 9 | 2 | [0, 0, 0, 5] |
| 10 | 0 | [1, 2, 0, 0] |
| 11 | 2 | [5, 5, 0, 0] |

When a reward function is generated (and also modified by IRL), to address the second question, the IRL's predictor may be used in a scheduling problem to show how IRL works in the objective-oriented traffic prediction problems. For the scheduling problem, consider the system model discussed previously: the downlink of a single-cell single-base station cellular network with users randomly distributed within the cell. Packets of different sizes and with different maximum-delay constraints arrive randomly for each user at each timeslot, and have to be scheduled by the network node 16 before their timer expires. If not served on time, the packets are dropped. Assume that full knowledge of the statistics including the packet arrival rates is obtained. However, assume here that there is no prior probabilistic information for the system model discussed previously. IRL may result in a benefit of predicting the size of packets arriving at the current and future timeslots given the previously arrived packets. This information may then be used by a Monte-Carlo Tree Search (MCTS) implementation to better schedule the packets.

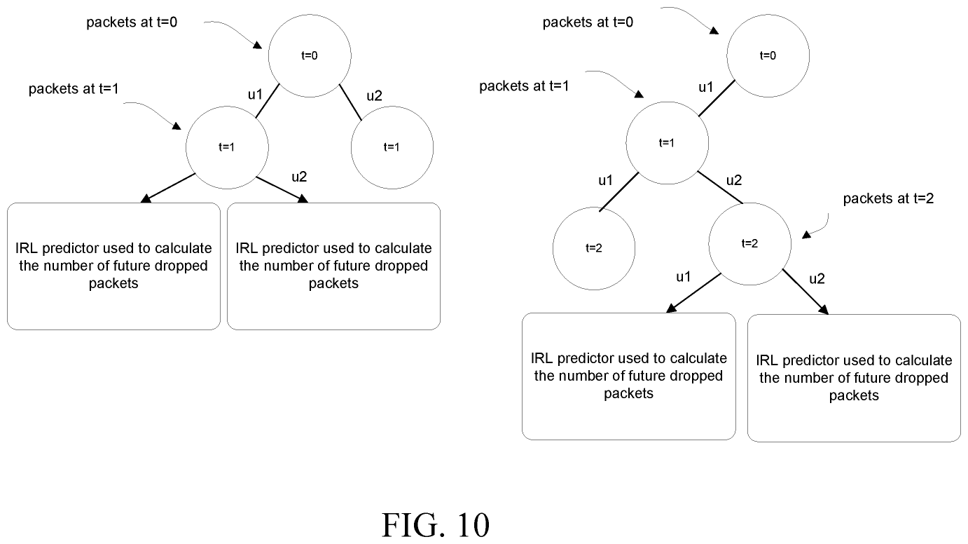

In the rollout step of MCTS, the IRL predictor may be used to predict the future packet arrivals and estimate the nodes' values, as demonstrated in FIG. 10. The left-hand side (right-hand side) tree demonstrates the rollout step at timeslot t=1 (t=2).

RL may be used for traffic flow prediction where the immediate reward for transition between samples xₜ₋₁ to xₜ (where xₜ is the sample arrived at time t) is proportional to the ratio of transitions from sample xₜ₋₁ to xₜ in the dataset. Here, consider a scenario with 2 or 3 users in a cell with buffer size of 5 and discrete packet sizes ranging from 1 to 5. Consider a case in which one user has a very high arrival rate and therefore, wrong predictions of arrival packet sizes may lead to buffer overflow for that user, in turn resulting in a large number of dropped packets.

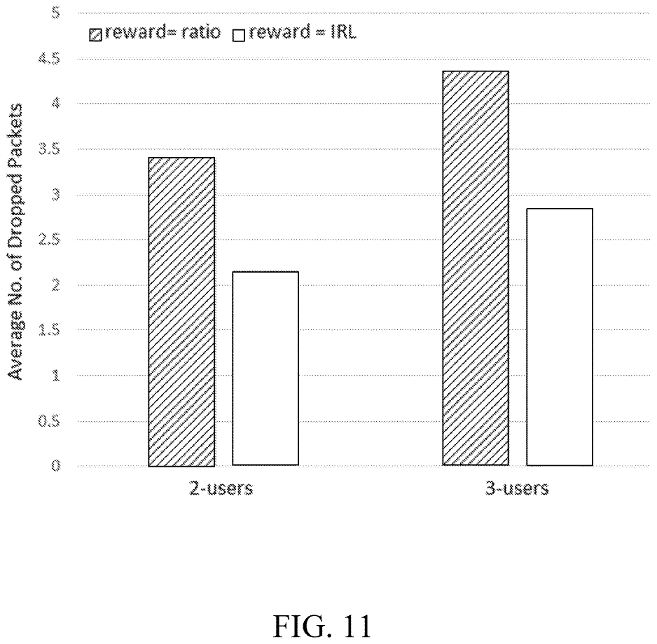

FIG. 11 illustrates a comparison of the total number of dropped packets considering the RL agent using the ratio as the reward with the IRL agent, using the modified reward function (demonstrated in FIG. 9) in which the actions resulting into the buffer overflow are prioritized. As shown here, the prediction as the objective is the total number of dropped packets, calling for different actions (even if they occur with the same ratio in the dataset) that may affect the performance differently. The accuracy of the IRL's predictor used in the results demonstrated in FIG. 11 is 91% considering the GAIL approach with 400 epochs with a learning rate of 0.005. The generator is implemented using the Proximal Policy Optimization (PPO) approach and the discriminator neural network uses four hidden layers.

As shown in FIG. 11, the IRL agent reduces the number of dropped packets compared to the RL agent. This may be applied to other scenarios in which prediction is required for objective optimization.

Memory and resource consumption: Similar to RL, IRL does not need any pre-sampling or pre-training using a dataset. In applications where latency plays a role, one alternative is to keep the IRL agent running in an online manner and use the achieved reward function after some tolerable accuracy level is reached. For other ML-based approaches, such as long short term memory (LSTM) as one of the bestknown techniques for traffic prediction, in case the problem statistics changes, observation of a large-enough amount of data and re-training of the model may occur until an acceptable accuracy level is reached. On the other hand, an IRL agent may easily adopt to the time-varying behavior of the system and reach the same levels of accuracy faster than other ML-based approaches such as supervised learning (SL). So, one alternative is to keep using the IRL agent and if time and memory allows, in case SL-based approach results in higher accuracy, re-train the more accurate SL-based approaches in parallel.

### Example Embodiments

Example A1. A network node 16, the network node 16 configured to, and/or comprising a radio interface and/or comprising processing circuitry 68 configured to:
generate by inverse reinforcement learning (IRL) a reward function, based at least in part on observations of behavior of an expert in terms of a sequence of state-action pairs, the expert behavior including predicting a next true sample based at least in part on a given set of previously received samples; and
predict a sequence of samples based at least in part on values of the reward function.

Example A2. The network node 16 of Example A1, wherein generating the reward function includes comparing by an IRL agent, state action pairs generated by interacting with the environment with state action pairs generated by the expert.

Example A3. The network node 16 of any of Examples A1 and A2, wherein the reward function is generated based at least in part on a priority of samples to be predicted.

Example A4. The network node 16 of Example A3, wherein a priority of samples to be predicted is based at least in part on whether samples result in a buffer overflow.

Example A5. The network node 16 of Example A3, wherein a priority of samples to be predicted is based at least in part on modification of a loss function of a similarity between predicted actions and real actions.

Example A6. The network node 16 of Example A5, wherein the loss function is determined based at least in part on an objective function.

Example A7. The network node 16 of Example A6, wherein the objective function includes a total number of dropped packets.

Example A8. The network node 16 of any of Examples A1-A7, wherein the processing circuitry 68 is further configured to predict a size of packets of samples arriving in at least one time slot.

Example A9. The network node 16 of Example A8, wherein the processing circuitry 68 is further configured to schedule the packets of samples based at least in part on a Monte Carlo Tree Search (MCTS).

Example A10. The network node 16 of any of Examples A1-A9, wherein generating the reward function is based at least in part on a model of a traffic prediction problem as a Markov Decision Process (MDP).

Example B1. A method implemented in a network node 16, the method comprising:
generating by inverse reinforcement learning (IRL) a reward function, based at least in part on observations of behavior of an expert in terms of a sequence of state-action pairs, the expert behavior including predicting a next true sample based at least in part on a given set of previously received samples; and
predicting a sequence of samples based at least in part on values of the reward function.

Example B2. The method of Example B1, wherein generating the reward function includes comparing by an IRL agent, state action pairs generated by interacting with the environment with state action pairs generated by the expert.

Example B3. The method of any of Examples B1 and B2, wherein the reward function is generated based at least in part on a priority of samples to be predicted.

Example B4. The method of Example B3, wherein a priority of samples to be predicted is based at least in part on whether samples result in a buffer overflow.

Example B5. The method of Example B3, wherein a priority of samples to be predicted is based at least in part on modification of a loss function of a similarity between predicted actions and real actions.

Example B6. The method of Example B5, wherein the loss function is determined based at least in part on an objective function.

Example B7. The method of Example B6, wherein the objective function includes a total number of dropped packets.

Example B8. The method of any of Examples B1-B7, further comprising predicting a size of packets of samples arriving in at least one time slot.

Example B9. The method of Example B8, further comprising scheduling the packets of samples based at least in part on a Monte Carlo Tree Search (MCTS).

Example B10. The method of any of Examples B1-B9, wherein generating the reward function is based at least in part on a model of a traffic prediction problem as a Markov Decision Process (MDP).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ARMA Autoregressive Moving Average
ARIMA Autoregressive Integrated Moving Average
DRL Deep Reinforcement Learning
GAIL Generative Adversarial Imitation Learning
GCL Guided Cost Learning
IIOT Intelligent Internet of Things
IRL Inverse Reinforcement Learning
LSTM Long Short-term Memory
M Moving Average
MCTS Monte-Carlo Tree Search
MDP Markov Decision Process
ML Machine Learning
PPO Proximal Policy Optimization
RL Reinforcement Learning
SL Supervised Learning

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node comprising processing circuitry configured to:
generate, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples; and
predict a sequence of samples based at least in part on the values of the reward function.

2. The network node of claim 1, wherein generating the reward function includes comparing, by an IRL agent, state action pairs generated by interacting with an environment using state action pairs generated by the expert.

3. The network node of claim 1, wherein the reward function is generated based at least in part on a priority of samples to be predicted.

4. The network node of claim 3, wherein the priority of samples to be predicted is based at least in part on whether the samples to be predicted impact an objective.

5. The network node of claim 3, wherein the priority of samples to be predicted is based at least in part a loss function of a similarity between predicted actions and real actions.

6. The network node of claim 5, wherein the priority of samples to be predicted is based at least in part on modification of the loss function.

7. The network node of claim 5, wherein the loss function is determined based at least in part on an objective function.

8. The network node of claim 1, wherein the processing circuitry is further configured to schedule, based on an objective, packets of samples arriving in at least one time slot.

9. The network node of claim 1, wherein generating the reward function is based at least in part on a model of a traffic prediction problem.

10. A method implemented in a network node, the method comprising:
generating, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples; and
predicting a sequence of samples based at least in part on the values of the reward function.

11. The method of claim 10, wherein generating the reward function includes comparing, by an IRL agent, state action pairs generated by interacting with an environment using state action pairs generated by the expert.

12. The method of claim 10, wherein the reward function is generated based at least in part on a priority of samples to be predicted.

13. The method of claim 12, wherein the priority of samples to be predicted is based at least in part on whether the samples to be predicted impact an objective.

14. The method of claim 12, wherein the priority of samples to be predicted is based at least in part a loss function of a similarity between predicted actions and real actions.

15. The method of claim 14, wherein the priority of samples to be predicted is based at least in part on modification of the loss function.

16. The method of claim 14, wherein the loss function is determined based at least in part on an objective function.

17. The method of claim 10, further comprising scheduling, based on an objective, packets of samples arriving in at least one time slot.

18. The method of claim 10, wherein generating the reward function is based at least in part on a model of a traffic prediction problem.

19. (canceled)

20. (canceled)

21. A computer-readable storage comprising instructions which, when executed on at least one processor, cause the at least one processor to carry out a method, the method comprising:
generating, by inverse reinforcement learning, IRL, a reward function for traffic prediction, the reward function having values and being generated based at least in part on observations of behavior of an expert in terms of a sequence of state-action pairs, the expert behavior including predicting a next true sample based at least in part on a given set of previously received samples; and
predicting a sequence of samples based at least in part on the values of the reward function.

22. The method of claim 11, wherein the reward function is generated based at least in part on a priority of samples to be predicted.
